(19) United States
(12) Patent Application Publication
(10) Pub. No.: US 2014/0086346 A1
(43) Pub. Date: Mar. 27, 2014

(54) METHOD AND SYSTEM FOR REMOVAL OF BASELINE WANDER AND POWER-LINE INTERFERENCE

(71) Applicant: Samsung Electronics Co., Ltd., Gyeonggi-do (KR)

(72) Inventors: Sabarimalai Manikandan MOTTAIYAN, Tamil Nadu (IN); Saurabh TYAGI, Uttar Pradesh (IN)

(73) Assignee: Samsung Electronics Co., Ltd., Gyeonggi-do (KR)

(21) Appl. No.: 14/029,034

(22) Filed: Sep. 17, 2013

(30) Foreign Application Priority Data
Sep. 21, 2012 (IN) 2956/DEL/2012
Aug. 9, 2013 (KR) 10-2013-0094505

(51) Int. Cl. H04B 3/30; H04B 3/54

(52) U.S. Cl. CPC H04B 3/30; H04B 3/542
USPC 375/257

(57) ABSTRACT

A system removes noise from a signal by dividing the signal into at least one processing block, constructing a transform matrix in response to the noise of the signal, estimating a transform coefficient of the signal and the constructed transform matrix, reconstructing the signal by using the estimated transform coefficient and the constructed transform matrix and displaying the reconstructed signal.

### CLAIM OF PRIORITY

This application claims the benefit under 35 U.S.C. §119(a) of an Indian patent application filed on Sep. 21, 2012 in the Indian Patent Office and assigned Serial No. 2956/DEL/2012 and under 35 U.S.C. §119(a) of a Korean patent application filed on Aug. 9, 2013 in the Korean Intellectual Property Office and assigned Serial No. 10-2013-0094505 the entire disclosure of each of which is hereby incorporated by reference.

### FIELD OF INVENTION

The present invention concerns a noise detection and removal system for concurrent removal of baseline wander and power-line interference of a signal, for example.

### BACKGROUND

A common problem in biosignals (electrocardiography (ECG), electroencephalogram (EEG), eletrogastrogram (EGG), phonocardiogram (PCG), electromyogram (EMG)) monitoring or acquisition is contamination of a biosignal with different artifacts and noise such as power-line noise, wideband noise (or baseline wander or baseline drift), lead wire/electrode noise, patient movement or activity noise, and other noises. For example, this noise often corrupts the ECG signal and renders it difficult to perform clinical evaluation using either visual inspection or computer aided ECG analysis. The baseline wander and power-line interference are significant noises that strongly affect overall performance of many ECG signal processing applications. Further, such noise may lead to inaccurate determination of signal endpoints, amplitude peaks, intervals, durations, and mask shapes of local components such as P, T, QRS, and U waves. As a result, the noise reduces the diagnostic and recognition accuracy of physiological signal acquisition or processing.

Different digital filtering systems implement digital signal processing (DSP) methods for removing baseline wander (or low-frequency artifact or baseline drift) and power-line interference. Such DSP methods include, for example, adaptive or digital filtering, blind source separation, extended or adaptive Kalman filtering, empirical mode decomposition, discrete wavelet or cosine transform, frequency domain filtering, fixed or adaptive notch filtering, high or low pass filtering, independent component analysis, least mean square filtering, multi-adaptive bionic wavelet transform, morphological filtering, non-linear filter banks, polynomial splining, statistical weighted moving average filtering, time-varying filtering, and various other methods.

Although the methods described above are effective in reducing or eliminating interfering signals, they may also cause distortion of ECG signals. Further, these methods involve computational complexity, require substantial memory space, and may impair processing reliability. A system according to invention principles addresses these deficiencies and related problems and provides a robust system for concurrent removal of baseline wander and power-line interference from a recorded or received signal.

### SUMMARY

A system according to invention principles concurrently removes baseline wander and power-line interference and its harmonics in a recorded or received signal and constructs a dictionary or transform matrix for concurrent removal of both the specific and complete noise features from a recorded or received signal. The system in an embodiment, constructs a signal based on an estimated coefficient and a dictionary matrix of a recorded or received signal and removes trends and periodic signals from a received or recorded signal.

A method removes noise from a signal by dividing the signal into at least one processing block, constructing a transform matrix in response to the noise of the signal, estimating a transform coefficient of the signal and the constructed transform matrix, reconstructing the signal by using the estimated transform coefficient and the constructed transform matrix and displaying the reconstructed signal.

In a feature, a regularization parameter is determined to control a fidelity and sparse constraint of the noise of the signal and a mean is subtracted from the signal. The noise comprises at least one of baseline wander, power-line interference, and harmonics of the power-line interference and the signal comprises a frequency component, wherein the frequency component varies in response to characteristics of a noise source. A length of the at least one processing block is determined based on cyclic duration of the signal and the transform matrix comprises a set of elementary functions for the frequency component of the signal.

In another feature, the set of elementary functions comprises at least one of cosine and sine functions for removal of the noise from the signal and the set of elementary functions of the transform matrix is determined based on a frequency of the signal. The transform matrix further comprises a plurality of column vectors of data, wherein the plurality of column vectors of data is for a signal portion less than the length of the signal. The transform matrix is constructed in response to the noise of the signal further comprises adjusting the set of elementary functions for removing the noise of the signal.

In yet another feature, the set of elementary functions is selected by determining shapes of the signal, wherein the set of elementary functions is adjusted based on the shapes of the signal and characteristics of the noise source. Also, the transform matrix is constructed as at least one of over-complete, under-complete, and critical transformation and the transform coefficient is estimated using at least one of L1-norm minimization algorithm and greedy algorithm. The at least one of baseline wander, power-line interference, and harmonics of the power-line interference, of the signal are concurrently removed, and a trend and periodic signal component are removed from the signal.

The transform matrix is constructed as at least one of over-complete, under-complete, and critical transformation. In an additional feature, a system removes noise from a signal using a data acquisition module configured to receive the signal from at least one electrode. A dictionary matrix generation module is configured to construct a dictionary matrix in response to the noise of the signal and a sparse coefficient estimation module is configured to estimate a transform coefficient of the signal and the constructed dictionary matrix. A digital signal processing module is configured to reconstruct the signal by using the estimated transform coefficient and the constructed dictionary matrix and a display module is configured to display the reconstructed signal. The transform matrix is constructed as at least one of over-complete, under-complete, and critical transformation.

In another feature, the digital signal processing module divides the signal into at least one processing block, determines a length of the at least one processing block based on cyclic duration of the signal, determines a regularization parameter to control a fidelity and sparse constraint of the noise of the signal, and performs a mean subtraction of the signal. The signal comprises a frequency component varying in response to characteristics of a noise source and the dictionary matrix comprises a set of elementary functions for the frequency component of the signal. The set of elementary functions comprises at least one of cosine and sine functions for removal of the noise from the signal.

In yet another feature, the dictionary matrix generation module is further configured to determine the set of elementary functions of the dictionary matrix based on the frequency of the signal. The dictionary matrix generation module is further configured to determine shapes of the signal, and adjust the set of elementary functions based on the shapes of the signal and characteristics of the noise source. Also the dictionary matrix further comprises a plurality of column vectors, wherein the plurality of column vectors is less than the length of the signal. The sparse coefficient estimation module further comprises a transform coefficient estimator configured to estimate the transform coefficient using at least one of L1-norm minimization algorithm and greedy algorithm. The digital signal processing module is further configured to remove a trend and periodic signal component in the signal.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 shows a block diagram of an ECG monitoring and transmission system, according to invention principles;

FIG. 2 shows a block diagram of a digital signal processing (DSP) system implemented by the system of the FIG. 1, according to invention principles;

FIG. 3 shows a sparse coefficient estimation module used by the DSP system of FIG. 2, according to invention principles;

FIG. 4 depicts graphs representing an example of experimental waveforms of a corrupted or noisy ECG signal, an estimated ECG signal, and an extracted baseline wander and 60 Hz power-line signal, according to invention principles;

FIG. 5 depicts graphs representing another example of experimental waveforms of a noisy or corrupted ECG signal, an estimated ECG signal, and an extracted baseline wander and 60 Hz power-line signal, according to invention principles;

FIG. 6 shows a flow diagram of a DSP method for concurrent removal of baseline wander and power-line interference,according to invention principles; and

FIG. 7 shows a computing unit using a system according to invention principles.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing methods are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The system concurrently removes baseline wandering (including low-frequency artifacts or baseline drifts) and power-interference of a recorded or received signal. The system constructs a composite dictionary matrix including a set of elementary functions (basis functions, elementary functions and elementary waveforms). The recorded or received signal is divided into non-overlapping blocks of length N for effective suppression of different shapes of baseline wander artifact. A transform coefficient of the signal is estimated by using a known L1-Norm minimization algorithm or a known matching greedy algorithm and the constructed composite dictionary matrix. The method includes reconstructing the recorded or received signal using an estimated transform coefficient and the composite dictionary matrix. The baseline wander and power-line interference is removed from the reconstructed signal without distorting clinical features of the signal.

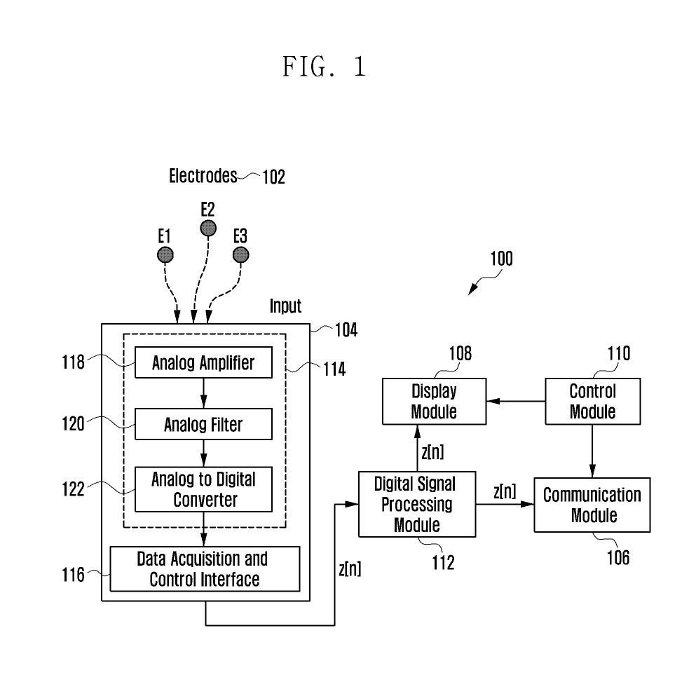

Referring now to the drawings, and more particularly to FIGS. 1 through 7, where similar reference characters denote corresponding features consistently throughout the figures.

Throughout the description, the terms composite dictionary matrix and transform matrix (or representation matrix or sparse matrix) are used interchangeably. The composite dictionary matrix may be constructed as an over-complete, under-complete and critical dictionary.

Throughout the description, the term elementary functions and elementary waveform (or basis functions or elementary atoms or elementary waveforms) is used interchangeably.

FIG. 1 depicts a block diagram of an ECG monitoring and transmission system 100, according to invention principles. The system 100 includes electrodes 102, a data acquisition (DAQ) module 104, a communication module 106, a display module 108, a control module 110, and a digital signal processing (DSP) module 112.

Information comprising data representing physiological conditions of a patient is measured by positioning the electrodes 102 on a patient body in specific locations. In an example, different channels are used to monitor electrical activity from different horizontal and frontal planes. The electrodes 102are placed in specific locations, for example, arms, legs, chest, and other specific locations to record cardiac bio-potential signals of the patient. The output of the electrodes 102 is provided to the DAQ module 104. The output of the electrodes comprises cardiac related electrical signals such as electrocardiogram (ECG) waveform signals, pacemaker pulse signals acquired by the electrodes, or other physiological parameters of the patient.

DAQ module 104 is configured to be coupled to the electrodes 102 to receive the cardiac bio-potentials of the patient. The DAQ module 104 includes a strip of multiple ECG electrodes having a connector terminal at one edge. The strip includes a number of electrodes spaced for placement on a patient of a particular size. Further, the data acquisition module 104 is configured to include an analog processing (AP) unit 114 and a data acquisition and control (DAQC) interface unit 116.

The DAQ module 104 receives an output representing a respective analog signal from the respective electrode 102 and provides the received output to the AP unit 114. The AP unit 114 is configured to include an analog amplifier 118, analog filter 120, and an analog to digital converter (ADC) 122 to amplify, filter, and convert the analog signals into digital signals. In an example, an output signal of the electrodes 102 is connected to an input of the analog amplifier 118 to amplify the signal. The output of the analog amplifier 118 is filtered by the analog filter 120 and the output of the analog filter 120 is digitized by the ADC 122.

The DAQC interface unit 116 processes multi-channel outputs for sending to electronic devices, for example, a desktop computer, laptop, tablet, Smartphone, Personal Digital Assistant (PDA), communicator, wearable computer, or another consumer electronic device. The DAQC interface unit 116 interfaces with an electronic device to receive real-time data using RS-232 or TIA-232-F standard, serial interface, Bluetooth, Ethernet, USB, TCP/IP devices, or another standard or interface. Further, the DAQC interface unit 116 is couples additional hardware, for example an electronic device used for diagnosing and monitoring a patient.

Communication module 106 communicates with local or remotely-located monitoring devices. The communication module 106 is configured for wired or wirelessly communicating the ECG signals, obtained from the patient, to the local or remotely-located monitoring devices. The local or remotely-located monitoring devices may be wired or wirelessly connected using one or more of, a cellular network, Radio-frequency identification (RFID), ZigBee, Bluetooth, Wi-Fi, Ultra-wideband (UWB), Worldwide Interoperability for Microwave Access (WiMax), or another method.

Display module 108 is configured to provide a graphical representation of the real-time multi-channel ECG signals on the local or remotely-located monitoring devices (for example, mobile communication devices). Display module 108 provides a screen type display and may be embodied in another known type of device. The control module 110, coupled to the communication module 106 and the display module 108, executes instructions controlling operation of system 100.

DSP module 112 is configured to receive the input signal (x[n]) from the DAQ module 104. The DSP module 112 is configured to remove artifacts and noises from the input signal. DAQ module 104 is configured to concurrently remove baseline wander, and 50/60 Hz power-line and its harmonics associated with the signal. The DSP module 112 implements a DSP method for constructing a transform matrix (Ψ) comprising a set of appropriate elementary functions to estimate a desired signal (z[n]) from the noisy signal. The DSP module 112 is coupled to the communication module 106 and the display module 108 to transmit and display the desired signal on the local and remotely-located monitoring devices.

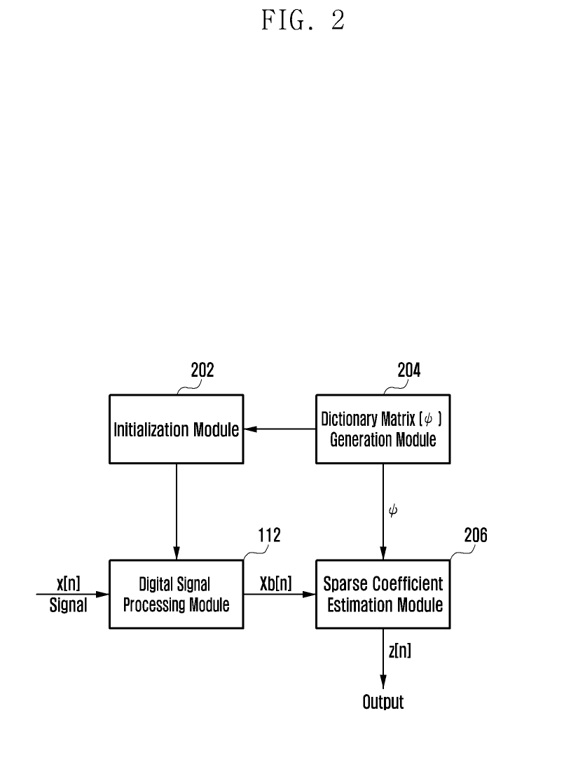

FIG. 2 depicts a block diagram of a digital signal processing (DSP) system of the system 100 of the FIG. 1. The DSP module 112 is configured to implement the DSP method for concurrent removal of a baseline wander and 50/60 Hz power-line noise and its harmonics in a recorded or received signal. The DSP system includes an initialization module 202 configured to initialize the input signal (x[n]), a block length (N), a regularization parameter (λ), and a dictionary matrix (Ψ).

In an example, the input signal x[n] includes a baseline wander and 50/60 Hz power-line interference signals. A frequency component of the input signal varies based on characteristics of different noise sources, for example, patient coughing, patient breathing, physical exercise, poor electrode contacts, perspiration of the patient under the electrodes 102, a dirty lead wire or electrode, patient movement, movement of cables, and another noise source. These noises can vary the frequency component of the signal, which may introduce the baseline wander and power-line interference during the signal transmission. The DSP module 112 is configured to specify a value of are gularization parameter to control fidelity and sparse constraint of the signal.

The DSP module 112 is configured to construct the dictionary matrix (Ψ) using a dictionary matrix generation module 204. The dictionary matrix includes a set of elementary functions (or elementary waveforms) for the frequency components of the signal. In an example, the set of elementary functions include Dirac's, Heaviside, Fourier, short-time Fourier transform, Discrete cosines, Discrete sine's, Haar, Wavelets, Wavelet packets, Gabor filters, Curvelets, Ridgelets, Contourlets, Bandelets, Shearlets, Directionlets, Grouplets, Chirplets, Hermite polynomials, Cubic ploynomials, and another function or prototype waveform. An appropriate and flexible dictionary matrix is constructed for an efficient representation of cardiac bio-potential ECG signals. The choice of the dictionary matrix affects the accuracy of signal estimation and computational complexity.

The dictionary matrix includes cosine or sine functions (or waveforms) for the frequency components of the ECG signal. In an example, the dictionary matrix include cosine waveforms with frequency components expected for the 50/60 Hz power-line interference and its harmonics with bandwidth of 1 Hz, and the frequencies from 0 Hz to the highest frequency (fₕ) Hz of the baseline wander.

The dictionary matrix (Ψ) with size of N×M (where M<N) is constructed from the discrete cosine functions or waveforms, which are computed as:

$${C}_{ij} = \{ \begin{matrix}\frac{1}{\sqrt{N}} , & i = 0 , 0 \leq j \leq N - 1 \\ \sqrt{\frac{2}{N}} cos ( \frac{π ( 2 j + 1 ) i}{2 N} ) , & 0 \leq j \leq M - 1 , 0 \leq j \leq N - 1\end{matrix}$$

The DSP module 112 receives the input signal x[n] and divides the input signal into non-overlapping processing blocks of the length N with a certain time duration (for example, 10 seconds). In an example, the DSP module 112 determines the length based on cyclic duration of input signal x[n]. The DSP module 112 performs the blocking of the input signal for effective suppression of different shapes of the baseline wander. The DSP module 112 performs a mean subtraction of the input signal x[n] and provides a zero-mean discrete-time signal x_{b}[n]. The mean subtraction provides a better estimation of a transform coefficient (α) of the signal.

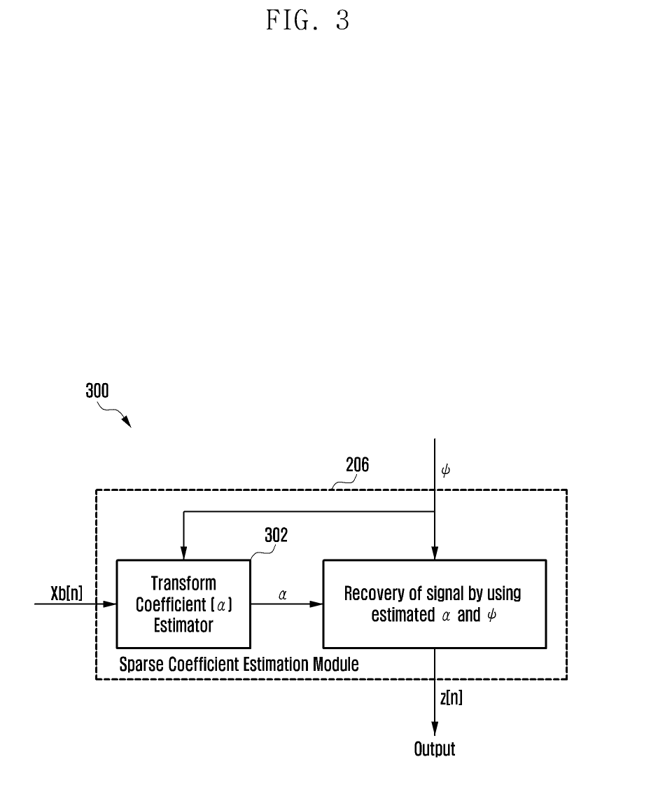

The DSP module 112 provides the zero-mean discrete-time signal x_{b}[n] to a sparse coefficient estimation module 206. The sparse coefficient estimation module 206 uses an L1-norm minimization algorithm or greedy algorithm to compute the transform coefficient (α) for the input signal x[n] and the constructed dictionary matrix (Ψ). The estimation of the transform coefficient using the sparse coefficient estimation module 206 is described in conjunction with FIG. 3.

The DSP module 112 is configured to construct a desired signal z[n] by using the estimated transform coefficient (α) and the dictionary matrix (Ψ). The DSP module 112 outputs the desired signal z[n] by the removing the baseline wander and the 50/60 Hz power-line and its harmonics without distorting the clinical features of the signal x[n].

The exemplary 50/60 Hz frequencies of the power-line described herein are only for illustrative purpose and should be considered as by way of example, but not by way limitation. The present invention is used to remove any type of power-line interference and its harmonics for 50/60 Hz or another power-line frequency without departing from the scope of invention

FIG. 3 depicts a framework 300 of a t sparse coefficient estimation module 206 of FIG. 2. The sparse coefficient estimation module 206 is configured to include a transform coefficient (α) estimator 302 to compute the transform coefficient using the L1-norm minimization algorithm or greedy algorithm.

In an embodiment, for the input signal x[n] and the dictionary matrix (Ψ), the transform coefficient (α) needs to be computed. In an example, the zero-mean discrete-time signal x_{b}[n] is provided to the transform coefficient (α) estimator 302. The transform coefficient (α) estimator 302 uses the L1-norm minimization algorithm or greedy algorithm to compute the transform coefficient (α). The transform coefficient (α) is estimated by solving the following optimization problem and minimization problem:

$$min {‖ α ‖}_{1} subject to x = Ψ α or$$

$$min {‖ α ‖}_{1} subject to {‖ Ψ α - x ‖}_{2} < ɛ or$$

$$\hat{α} = {argmin}_{α} {‖ Ψ α - x ‖}_{2}^{2} + λ {‖ α ‖}_{1}$$

Where, ∥Ψα−x∥₂² is fidelity term, ∥α∥₁ is a sparsity term, x is the signal to be decomposed, and λ is the regularization parameter that controls the relative importance of the fidelity and sparseness terms.

The filtered or output signal z[n] with size of N×1 is computed as:

$$z = Ψ \hat{α} = {\sum }_{m = 1}^{M} {\hat{α}}_{m} {ψ}_{m} , ψ ∈ {R}^{N \times 1} .$$

The DSP module 112, in communication with the sparse coefficient estimation module 206, constructs the output signal z[n] by using the estimated transform coefficient (α) vector and the dictionary matrix (Ψ). The output signal z[n] is free from baseline wander and power-line interference and its harmonic components. The output signal z[n] is displayed on the local or remotely-located devices using the display module 108.

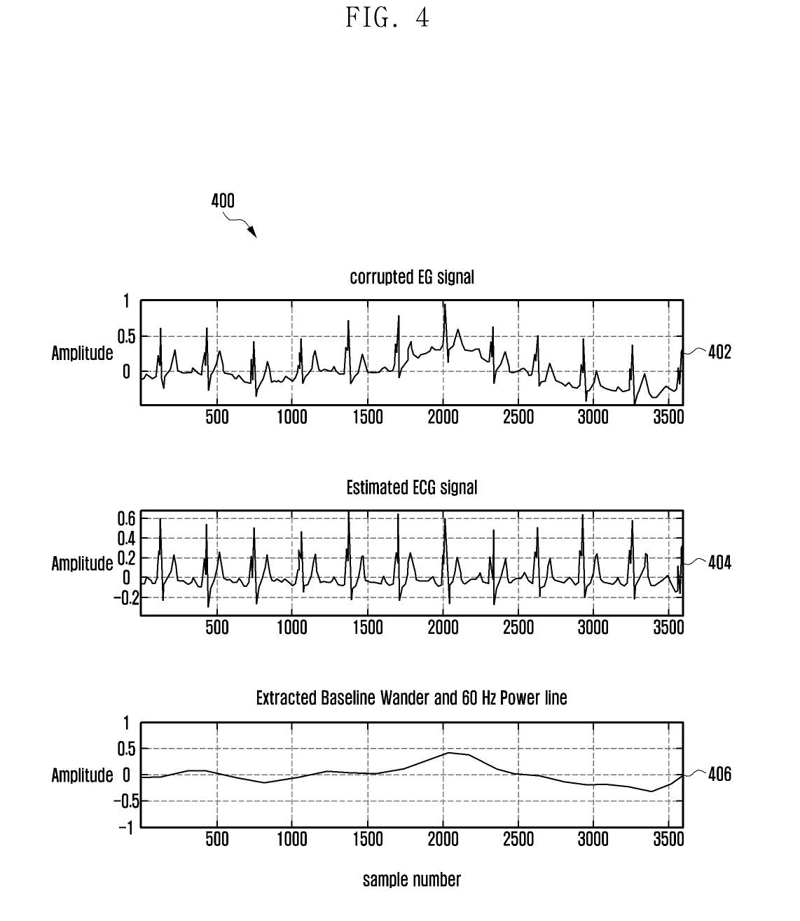

FIG. 4 depict graphs 400 representing experimental waveforms of a corrupted, noisy ECG signal 402, an estimated ECG signal 404, and an extracted baseline wander and 60 Hz power-line signal 406. The performance of the system is evaluated using the exemplary noisy, corrupted ECG signal 402. The noisy, corrupted ECG signal 402 represents the original waveform of 10 seconds duration received from electrodes positioned on a patient, where no DSP methods are applied. The noisy or corrupted ECG signal 402 is contaminated by the baseline wander and 60 Hz power-line noise, which corrupts the original signal and renders it difficult to read. The estimated ECG signal 404 represents the desired waveform constructed by using the DSP method. The baseline wander and the 60 Hz power-line noises are removed from the estimated ECG signal 404, using the DSP system, without distorting the cardiac bio-potentials of the noisy or corrupted ECG signal 402. The shape of the extracted baseline wander is represented in the signal 406.

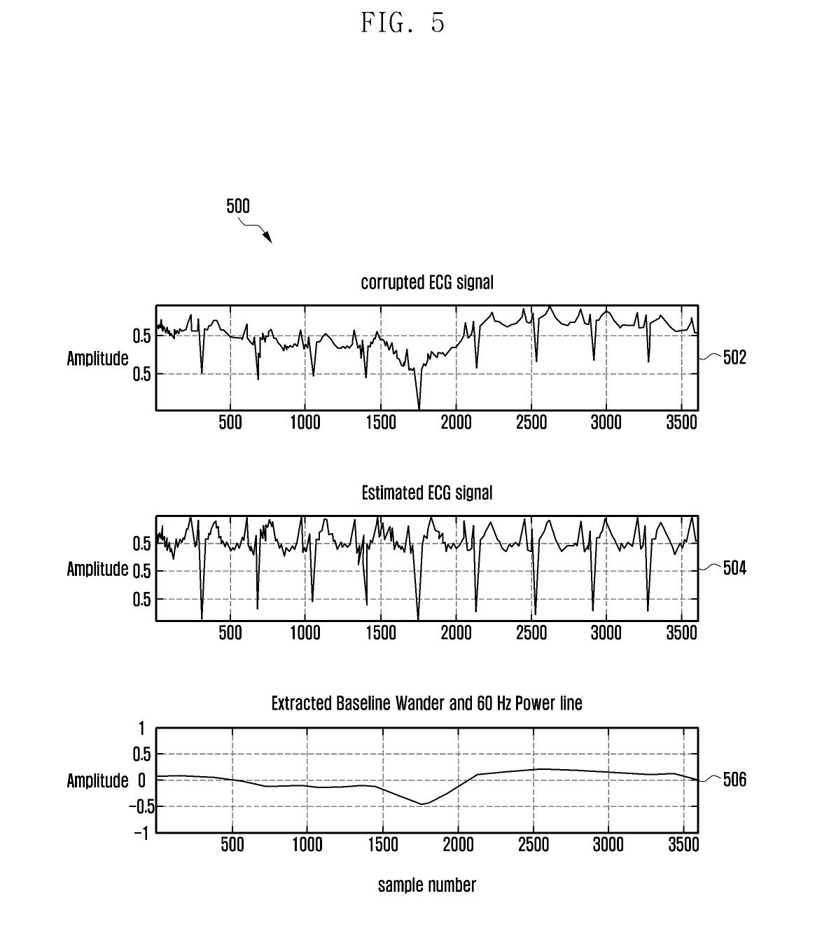

FIG. 5 shows graphs 500 representing further experimental waveforms of a noisy or corrupted ECG signal 502, an estimated ECG signal 504, and an extracted baseline wander and 60 Hz power-line signal 506. The noisy or corrupted ECG signal 502 represents the original waveform of 10 seconds duration received from electrodes positioned on a patient. The noisy or corrupted ECG signal 502 includes sharp P waves, QRS complexes, muscle artifacts, baseline wander, and 60 Hz power-line artifacts, which corrupt the original signal and render it difficult to read. The estimated ECG signal 504 represents the desired waveform constructed by using the DSP system. The baseline wander, the 60 Hz power-line, and the muscle artifacts are removed from the estimated ECG signal 504, using the DSP system, without distorting the cardiac bio-potentials of the noisy, corrupted ECG signal 502. The shape of the extracted baseline wander is represented in the waveform signal 506.

The performance of the system is dynamically evaluated using noisy ECG signals taken from the standard MIT-BIH arrhythmia database at “Moody G B, Mark R G, The impact of the MIT-BIH Arrhythmia Database” www.physionet.org/physiobank/database/mitdb/”. Preliminary experimental results of the method are shown in FIGS. 4 and 5 indicating successful removal of the baseline wander and the power line interference noises without distorting the morphological content of the local waves of the ECG signal.

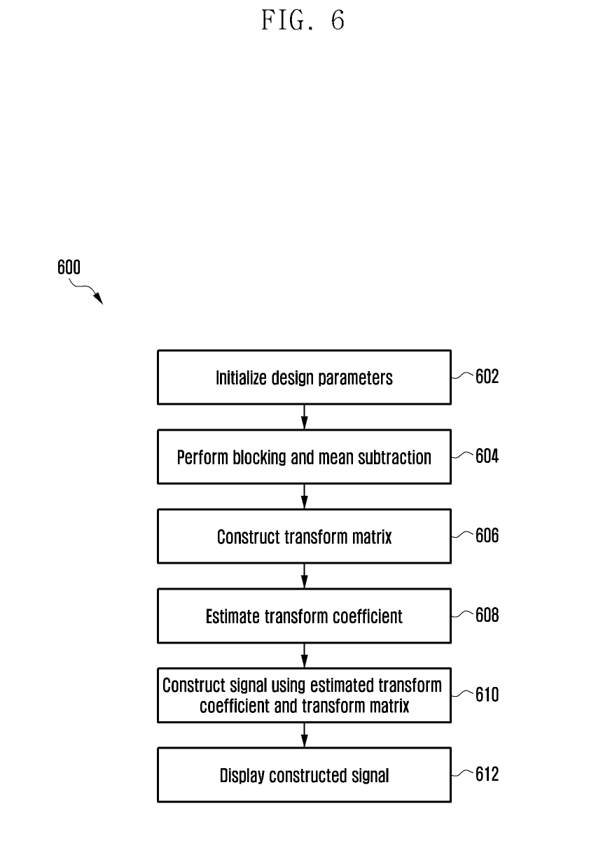

FIG. 6 depicts a flow diagram 600 of a DSP method for concurrent removal of baseline wander and power-line interference. At step 602, the DSP module 112 initializes design parameters. In an example, the DSP module 112 receives the input signal x[n] from the DAQ module 104. The DSP module 112 initializes the input signal (x[n]), a block length (N), a regularization parameter (λ), and a transform matrix (Ψ).

At step 604, the DSP module 112 performs blocking and subtraction of the mean from the input signal x[n]. In an example, the DSP module 112 divides the input signal into non-overlapping processing blocks of length N based on cyclic duration (for example, 10 seconds). The DSP module 112 performs the blocking of the signal x[n] for suppression of different shapes of the baseline wander. In an example, the DSP module 112 performs a mean subtraction of the signal x[n] and provides a zero-mean discrete-time signal x_{b}[n] for better estimation of a transform coefficient (α) of the signal x[n]. The DSP module 112 is configured to specify a value of the regularization parameter to control fidelity and sparse constraint of the input signal x[n].

At step 606, the transform matrix or dictionary matrix (Ψ) generation module 204 constructs the transform matrix (Ψ) for the signal x[n]. In an example, the transform matrix includes cosine elementary functions (or waveforms) for the frequency components of the ECG signal. The transform matrix (Ψ) with size of N×M (where M<N) is constructed from the discrete cosine functions or waveforms, which are computed as:

$${C}_{ij} = \{ \begin{matrix}\frac{1}{\sqrt{N}} , & i = 0 , 0 \leq j \leq N - 1 \\ \sqrt{\frac{2}{N}} cos ( \frac{π ( 2 j + 1 ) i}{2 N} ) , & 0 \leq j \leq M - 1 , 0 \leq j \leq N - 1\end{matrix}$$

Depending on the temporal and spectral characteristics of input signal x[n] and the encountered noise, the dictionary matrix is constructed by using the elementary waveforms and prototype waveforms as previously described.

At step 608, the sparse coefficient estimation module 206 estimates the transform coefficient (α) of the zero-mean discrete-time signal x_{b}[n]. The sparse coefficient estimation module 206 uses the L1-norm minimization algorithm or greedy algorithm to compute the transform coefficient (α) for the input signal x[n] and the constructed transform matrix (Ψ). The transform coefficient (α) is estimated by solving the following optimization problem and minimization problem:

$$min {‖ α ‖}_{1} subject to x = Ψ α or$$

$$min {‖ α ‖}_{1} subject to {‖ Ψ α - x ‖}_{2} < ɛ or$$

$$\hat{α} = {argmin}_{α} {‖ Ψ α - x ‖}_{2}^{2} + λ {‖ α ‖}_{1}$$

Where, ∥Ψα−x∥₂² is a fidelity term, ∥α∥₁ is a sparsity term, x is the signal to be decomposed, and λ is a regularization parameter that controls the relative importance of the fidelity and sparseness terms.

At step 610, the DSP module 112, in communication with the sparse coefficient estimation module 206, constructs an output signal z[n] using the estimated the transform coefficient (α) and the transform matrix (Ψ). In an example, the DSP module 112 constructs the output signal z[n] by removing the baseline wander and power-line interference and its harmonics, without distorting the cardiac bio-potentials of the input signal x[n]. The output signal z[n] with size of N×1 is computed as:

$$z = Ψ \hat{α} = {\sum }_{m = 1}^{M} {\hat{α}}_{m} {ψ}_{m} , ψ ∈ {R}^{N \times 1}$$

At step 612, the display module 108 displays the output signal z[n] on the local or remotely-located devices.

Though the above description is described with respect to an ECG monitoring system, a person skilled in art will readily appreciate the system may be used in other DSP systems. The system removes trend and periodic signal components from a signal and concurrently removes other type of specific or complete noise from a recorded or received signal, without departing from the scope of the invention.

In an example, a method of removing signal drifts in a speech communication system uses the DSP system. Consider a real-valued, finite-length, one-dimensional, and discrete-time input signal x=[x[1], x[2], . . . x[N]]^{T}, where T denotes a matrix transpose.

The signal vector x is represented as a linear combination of the elementary waveforms as the column vectors {ψₘ}ₘ₌₁^{M} in the dictionary matrix (Ψ). The signal vector x is represented as:

$$x = Ψ α = {\sum }_{m = 1}^{M} {α}_{m} {ψ}_{m} , {ψ}_{m} ∈ {R}^{N \times 1} .$$

Where, α=[α₁,α₂,α₃, . . . α_{M}] is the transform coefficient vector that is computed as αₘ= [symbol] x,ψₘ [symbol] . For example, if the Ψ comprises elementary discrete cosine waveforms, α is the vector of a discrete cosine transform (DCT) coefficients. An appropriate and flexible dictionary matrix is constructed for an efficient representation of the signal x[n]. The dictionary matrix (Ψ), with size of N×M (where M<N), is constructed from the discrete cosine waveforms, which are computed as:

$${C}_{ij} = \{ \begin{matrix}\frac{1}{\sqrt{N}} , & i = 0 , 0 \leq j \leq N - 1 \\ \sqrt{\frac{2}{N}} cos ( \frac{π ( 2 j + 1 ) i}{2 N} ) , & 0 \leq j \leq M - 1 , 0 \leq j \leq N - 1\end{matrix}$$

The blocking and mean subtraction of the signal x[n] is performed for effective estimation of the transform coefficient (α). A value for the regularization parameter (λ) is specified to control fidelity and sparse constraint of the signal x[n]. The transform coefficient (α) is estimated by solving the following optimization problem:

$$z = Ψ \hat{α} = {\sum }_{m = 1}^{M} {\hat{α}}_{m} {ψ}_{m} , ψ ∈ {R}^{N \times 1}$$

A filtered or reconstructed signal z[n] with size of N×1 is computed as:

$$min {‖ α ‖}_{1} subject to x = Ψ α or$$

$$min {‖ α ‖}_{1} subject to {‖ Ψ α - x ‖}_{2} < ɛ or$$

$$\hat{α} = {argmin}_{α} {‖ Ψ α - x ‖}_{2}^{2} + λ {‖ α ‖}_{1}$$

The output signal z[n] is constructed by removing the drifts and other artifacts from the signal x[n], without distorting voice data of the signal x[n].

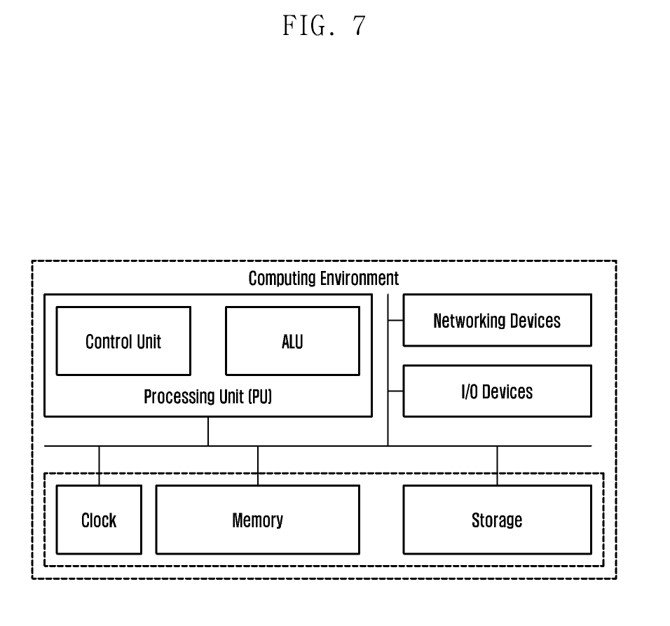

FIG. 7 shows a computing system comprising at least one processing unit including a control unit and an Arithmetic Logic Unit (ALU), a memory, a storage unit, a clock chip, plurality of networking devices, and a plurality Input output (I/O) devices. The processing unit processes instructions comprising an algorithm and receives commands from the control unit in order to perform its processing. Further, logical and arithmetic operations involved in the execution of the instructions are performed with the help of the ALU.

The processing unit may comprise multiple homogeneous and/or heterogeneous cores, multiple CPUs of different kinds, special media and other accelerators. The processing unit responds to commands received from the control unit in performing processing. Further, logical and arithmetic operations involved in the execution of the instructions are computed with the help of the ALU and the plurality of process units may be located on a single chip or multiple chips.

In an embodiment an algorithm comprising instructions and codes used by the system is stored in either the memory unit or storage or both. At the time of execution, the instructions may be fetched from the corresponding memory and/or storage, and executed by the processing unit. The processing unit synchronizes the operations and executes the instructions based on the timing signals generated by the clock chip.

The system may be implemented by at least one software program running on at least one hardware device and performing network management functions to control the elements. The elements shown in FIGS. 1-3 and 6 include blocks which may comprise at least one of a hardware device, or a combination of hardware device and software module.

The foregoing description as modified in the light of current knowledge, may be readily modified and/or adapted for various applications and are contemplated to be within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The above-described embodiments can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. The functions and process steps herein may be performed automatically or wholly or partially in response to user command. An activity (including a step) performed automatically is performed in response to executable instruction or device operation without user direct initiation of the activity. No claim element herein is to be construed under the provisions of 35 U.S.C. 112, sixth paragraph, unless the element is expressly recited using the phrase “means for.”

What is claimed is:

1. A method for removing noise from a signal, the method comprising:
dividing the signal into at least one processing block;
constructing a transform matrix in response to the noise of the signal;
estimating a transform coefficient of the signal and the constructed transform matrix;
reconstructing the signal by using the estimated transform coefficient and the constructed transform matrix; and
displaying the reconstructed signal.

2. The method of claim 1, wherein the method further comprises determining a regularization parameter to control a fidelity and sparse constraint of the noise of the signal.

3. The method of claim 1, wherein the method further comprises subtracting a mean from the signal.

4. The method of claim 1, wherein the noise comprises at least one of baseline wander, power-line interference, and harmonics of the power-line interference.

5. The method of claim 1, wherein the signal comprises a frequency component, wherein the frequency component varies in response to characteristics of a noise source.

6. The method of claim 1, wherein the method further comprises determining a length of the at least one processing block based on cyclic duration of the signal.

7. The method of claim 1, wherein the transform matrix comprises a set of elementary functions for the frequency component of the signal.

8. The method of claim 6, wherein the set of elementary functions comprises at least one of cosine and sine functions for removal of the noise from the signal.

9. The method of claim 1, wherein the method further comprises determining a set of elementary functions of the transform matrix based on a frequency of the signal.

10. The method of claim 1, wherein the transform matrix further comprises a plurality of column vectors of data, wherein the plurality of column vectors of data is for a signal portion less than the length of the signal.

11. The method of claim 1, wherein constructing the transform matrix in response to the noise of the signal further comprises adjusting a set of elementary functions for removing the noise of the signal.

12. The method of claim 8, including adjusting the set of elementary functions by determining shapes of the signal, wherein the set of elementary functions is adjusted based on the shapes of the signal and characteristics of the noise source.

13. The method of claim 1, wherein the transform matrix is constructed as at least one of over-complete, under-complete, and critical transformation.

14. The method of claim 1, wherein the transform coefficient is estimated using at least one of L1-norm minimization algorithm and greedy algorithm.

15. The method of claim 1, wherein the method further comprises concurrently removing at least one of baseline wander, power-line interference, and harmonics of the power-line interference, of the signal.

16. The method of claim 1, wherein the method further comprises removing a trend and periodic signal component from the signal.

17. A system for removing noise from a signal, the system comprising:
a data acquisition module configured to receive the signal from at least one electrode;
a dictionary matrix generation module configured to construct a dictionary matrix in response to the noise of the signal;
a sparse coefficient estimation module configured to estimate a transform coefficient of the signal and the constructed dictionary matrix;
a digital signal processing module configured to reconstruct the signal by using the estimated transform coefficient and the constructed dictionary matrix; and
a display module configured to display the reconstructed signal.

18. The system of claim 1, wherein the digital signal processing module is further configured to:
divide the signal into at least one processing block,
determine a length of the at least one processing block based on cyclic duration of the signal,
determine a regularization parameter to control a fidelity and sparse constraint of the noise of the signal, and
perform a mean subtraction of the signal.

19. The system of claim 17, wherein the noise comprises at least one of baseline wander, power-line interference, and harmonics of the power-line interference.

20. The system of claim 17, wherein the signal comprises a frequency component varying in response to characteristics of a noise source.

21. The system of claim 17, wherein the dictionary matrix comprises a set of elementary functions for the frequency component of the signal.

22. The system of claim 21, wherein the set of elementary functions comprises at least one of cosine and sine functions for removal of the noise from the signal.

23. The system of claim 17, wherein the dictionary matrix generation module is further configured to determine the set of elementary functions of the dictionary matrix based on the frequency of the signal.

24. The system of claim 17, wherein the dictionary matrix generation module is further configured to:
determine shapes of the signal, and
adjust the set of elementary functions based on the shapes of the signal and characteristics of the noise source.

25. The system of claim 17, wherein the dictionary matrix further comprises a plurality of column vectors, wherein the plurality of column vectors is less than the length of the signal.

26. The system of claim 17, wherein the dictionary matrix is constructed as at least one of over-complete, under-complete, and critical dictionary.

27. The system of claim 17, wherein the sparse coefficient estimation module further comprises a transform coefficient estimator configured to estimate the transform coefficient using at least one of L1-norm minimization algorithm and greedy algorithm.

28. The system of 17, wherein the digital signal processing module is further configured to remove a trend and periodic signal component in the signal.
